(19) United States
(12) Patent Application Publication
(10) Pub. No.: US 2026/0338479 A1
(43) Pub. Date: Oct. 29, 2026

(54) TEMPERATURE CONTROL DEVICE, IN PARTICULAR COOLING DEVICE FOR A MOTOR VEHICLE

(71) Applicant: VALEO SYSTEMES THERMIQUES, Le Mesnil-Saint-Denis (FR)

(72) Inventors: Christophe Herault, Le-Mesnil-Saint-Denis Cedex (FR); Etienne Chardin, Le-Mesnil-Saint-Denis Cedex (FR)

(73) Assignee: VALEO SYSTEMES THERMIQUES, Le Mesnil-Saint-Denis (FR)

(21) Appl. No.: 19/099,778

(22) PCT Filed: Jul. 17, 2023
(86) PCT No.: PCT/EP2023/069808

§ 371 Date: Jan. 30, 2025

(30) Foreign Application Priority Data
Aug. 2, 2022 (FR) FR2208019

(51) Int. Cl. F28D 1/053; F28D 1/03; F28D 1/047; F28D 21/00; H01M 10/613

(52) U.S. Cl. CPC F28D 1/05358; F28D 1/0391; F28D 1/0478; H01M 10/613; F28D 2021/0043

(57) ABSTRACT

A thermal regulation device includes a tube configured to be in contact with at least one electrical energy storage unit. The tube includes a plurality of heat transfer fluid circulation channels, and at least a first collecting tank. The first collecting tank includes at least two shells configured to be assembled together. At least one of the shells includes at least one separating partition in order to separate the collecting chamber into at least two parts that are leak-tight with respect to one another when the shells are assembled. At least one separating partition is obtained by stamping, and the base of the separating partition includes a stamped portion forming a groove configured to include the angle due to stamping, such that the end of the separating partition has a face parallel to the face of the end of the tube.

The present invention relates to a thermal regulation device, in particular a cooling device, in particular for an electrical component that may release heat during its operation, in particular a cooling device for at least one battery or battery cell of a vehicle, for example one vehicle. The vehicle may be a land vehicle, marine vehicle or air vehicle.

Nowadays, it is known for electric, thermal or hybrid vehicles to be equipped with electrical energy storage units permitting supply of electric power to the different elements of the vehicle. These electrical energy storage units are generally composed of electrical energy storage cells positioned in a battery pack.

Automotive manufacturers are nowadays seeking to supply more powerful electric or hybrid vehicles, and which have increased electrical autonomy. To this end, more and more battery packs, and/or larger and larger battery packs, are installed on these electric or hybrid vehicles. It is known for the entirety or at least a portion of these battery packs to be installed in the floor of the vehicle, substantially over the entire width of the vehicle.

It is understood that, when the vehicle is running, the battery packs can release a large quantity of heat and consequently be subjected to temperature increases that can in certain cases damage or even destroy them. Therefore, their cooling is essential in order both to keep them in good condition and to ensure the reliability, range and performance level of the vehicle. Furthermore, the operation of the battery packs can be less efficient in the event of low temperatures, with the electrical or electronic components equipping these battery packs then needing time to build up temperature before operating at full capacity.

For this purpose, one or more thermal regulation devices designed to regulate the temperature of the battery packs are implemented so as to assure the heating and/or cooling functions of the electrical or electronic components inside these battery packs and to thus optimize the operation of the different components.

These thermal regulation devices are generally passed through by a heat transfer fluid which can, according to requirements, either absorb the heat emitted by each battery pack in order to cool it, or supply heat if the temperature of the battery pack is insufficient for good operation thereof.

In battery packs in which electrical energy storage cells are disposed vertically one beside the other so as to form a plurality of successive rows of cells, it is notably known to have thermal regulation devices having a tube which is disposed between two rows of cells and within which the heat transfer fluid is able to circulate. The contact between the tube and the cells allows heat energy to be discharged, or supplied, via the heat transfer fluid. To manage the intake and discharge of the heat transfer fluid, a fluid collecting tank is disposed at one end of the tube and heat transfer fluid intake and outlet ducts are connected to this collecting tank.

More particularly, when a plurality of thermal regulation devices are disposed in parallel in order to be inserted between two rows of cells, and the ducts must be connected in succession to each collecting tank of the thermal regulation devices, it is known to form the intake duct and the outlet duct for heat transfer fluid by a succession of tube portions including sleeves secured to each collecting tank and additional connection means interposed between the sleeves in order to fix them to one another and allow heat transfer fluid to pass in a leak-tight manner within each of the tube portions.

The size of the battery packs must be larger and larger in order to meet the increasing electrical energy needs of modern electric or hybrid vehicles, and the number of rows of cells, and therefore the number of tubes interposed between these rows of cells in order to effect thermal regulation, must be larger and larger. As a result, the connection of the ducts to the different collecting tanks can be laborious owing to the large number of parts to be assembled with one another.

Furthermore, multiplication of the number of parts and of their respective manufacturing tolerances means larger assembly sets and increased complexity in order to effect this assembly.

One example of a thermal regulation device for cooling electrical energy storage units consists of a thermal regulation device comprising a tube configured to be in contact with the electrical energy storage units and comprising at least one heat transfer fluid circulation channel, a collecting tank disposed at one end of the tube and comprising collecting chambers which communicate fluidically with the at least one circulation channel of the tube, and at least two connecting sleeves disposed on either side of the collecting tank and configured to communicate with the same collecting chamber, the connecting sleeves having different shapes from one another.

The demand is even greater for thermal regulation devices for cooling electrical energy storage units, the thermal exchange efficiency of which is improved.

For reasons of ease of manufacture, at least the collecting tanks of such thermal regulation devices are formed by stamping, for example of metal such as aluminum. Stamping thus makes it possible to form reliefs in a relatively simple manner, but this technique does not make it possible to form right angles. Indeed, stamping creates a rounded portion, here called the stamping radius, which gives rise to approximations of reliefs which are assumed to be straight.

When the collecting tank comprises different compartments, it is known to separate the compartments by reliefs of the tank itself, by a separating partition.

However, owing to the stamping radius, it is impossible to place the tube in contact with the vertical wall of the conventional collecting tanks. Indeed, contact is not perfect owing to this rounded portion where the straight tube is pushed in abutment into the collecting tank as far as a separating partition. Consequently, there is a leak (called a by-pass) between the incoming and outgoing flows. The cooling performance is thus diminished.

The present invention aims to solve this technical problem by proposing a specific device that allows the cooling performance to be improved.

Accordingly, the present invention relates to a thermal regulation device for cooling electrical energy storage units, the thermal regulation device comprising a tube configured to be in contact with at least one electrical energy storage unit, the tube comprising a plurality of heat transfer fluid circulation channels,
at least one first collecting tank disposed at a first end of the tube, the first collecting tank comprising at least two shells configured to be assembled together to form a collecting chamber which communicates fluidically with the plurality of circulation channels of the tube,
at least one of said shells, preferably both shells, comprise at least one separating partition having one end configured to be in contact with one end of the tube when the two shells are assembled with said tube, in order to separate the collecting chamber into at least two parts which are leak-tight with respect to one another when the shells are assembled, each of the parts communicating fluidically with one portion of the plurality of circulation channels, characterized in that at least one separating partition, preferably both separating partitions, is obtained by stamping, and in that the base of said separating partition comprises a stamped portion forming a groove, the groove being configured to comprise the angle due to stamping, such that the end of the separating partition has a face parallel to the face of the end of the tube.

The technical solution thus consists in positioning a groove at the bottom of the wall of the separating partition, so that this groove comprises the stamping radius, without interference with the tube.

Advantageously, this makes it possible to ensure verticality of the wall of the separating partition that is in contact with the end of the tube, so as to ensure leak-tight contact between the two elements and thus ensure separation between the flows of the collecting tank.

Preferably, this invention may have several optional aspects:

According to a feature of the invention, the end of the separating partition of each shell has a vertical wall configured to be in continuous contact with the end of the tube.

According to a feature of the invention, the separating partition is in contact with the tube in the region of at least one channel of the plurality of distribution channels.

According to a feature of the invention, the channel in contact with the separating partition is full

According to a feature of the invention, the channel in contact with the separating partition is empty, the separating partition being dimensioned to block the channel when the two shells of the collecting tank are assembled with the tube.

According to a feature of the invention, the device comprises a second stamped portion at the top of the separating partition, said second stamped portion being configured to reduce the stamping radius of said top such that the end of the separating partition has a face parallel to the face of the end of the tube.

This advantageously makes it possible to obtain as small a radius as possible at the top of the wall.

In other words, the second stamped portion makes it possible to reduce the stamping radius that is present in the region of the angle between the face of the end of the separating partition, which is intended to be disposed in contact with the face of the end of the tube, and the face forming the top of the separating partition.

According to another feature of the invention, the second stamped portion is formed so as to obtain substantially a right angle in the region of the top.

According to a feature of the invention, the device comprises a second collecting tank at a second end of the tube opposite the first end of the tube comprising the first collecting tank, the second collecting tank being identical to the first collecting tank.

According to a feature of the invention, the two shells are symmetrical.

According to a feature of the invention, the trough has a depth of between 0.05 mm and 0.2 mm.

Advantageously, the depth of this trough is dimensioned such that it allows the radius at the foot of the wall to be made smaller and preferably also to be filled by the solder joint.

According to a feature of the invention, the collecting tank is made of metal, such as aluminum, or of plastics material.

According to a feature of the invention, at least one of the shells, preferably both shells, comprises orifices.

According to a feature of the invention, at least two connecting sleeves, preferably four, are configured to communicate fluidically with the collecting chamber, preferably with each part of the collecting chamber, the connecting sleeves preferably having different shapes from one another.

The invention relates also to a thermal regulation system comprising several thermal regulation devices as described above, and several electrical energy storage units disposed in a row, the regulation devices being connected to one another by their sleeves and being configured to be in contact with said rows of storage units.

The invention relates also to a method for assembling a thermal regulation device as described above, said method comprising the following steps:
two shells are provided and are stamped so as to form a separating partition of the collecting chamber, the separating partition comprising at its base a stamped portion forming a trough having the stamping radius, also called the residual stamped portion,
the two shells are assembled with one another to form said collecting tank forming the collecting chamber,
a tube comprising a plurality of heat transfer fluid circulation channels (8) is provided and is introduced into the collecting tank, such that one end of the tube is in contact with one end of the separating partition,
the assembly of the shells and the tube is fixed by soldering, adhesive bonding, welding, clipping, ultrasound, or a mixture thereof.

According to a feature of the invention, the stamped region forming the trough is produced in a second stamping step.

According to a feature of the invention, the method further comprises a step of stamping the top of the separating partition so as to reduce the stamping radius of said top such that the end of the separating partition has a face parallel to the face of the end of the tube.

Other features, details and advantages of the invention will become more clearly apparent from reading the following description, on the one hand, and from several exemplary embodiments, which are given by way of information and without implying any limitation with reference to the accompanying schematic drawings, on the other hand, in which:

FIG. 1 is a representation, in perspective, of a battery pack in its entirety that is equipped with several electrical energy storage units and with a plurality of thermal regulation devices according to one example;

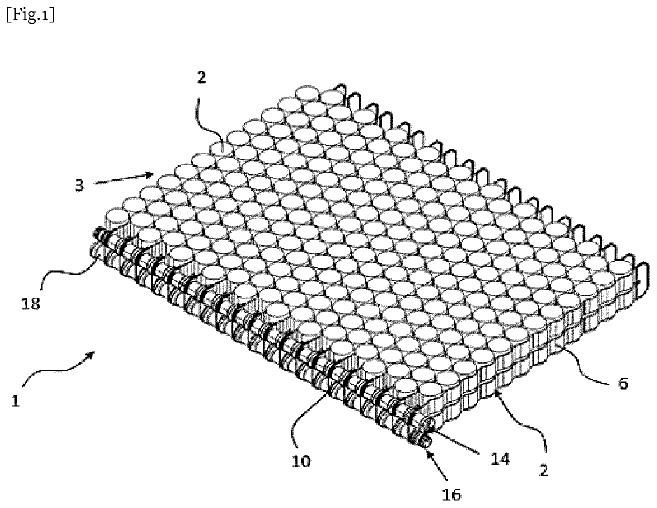

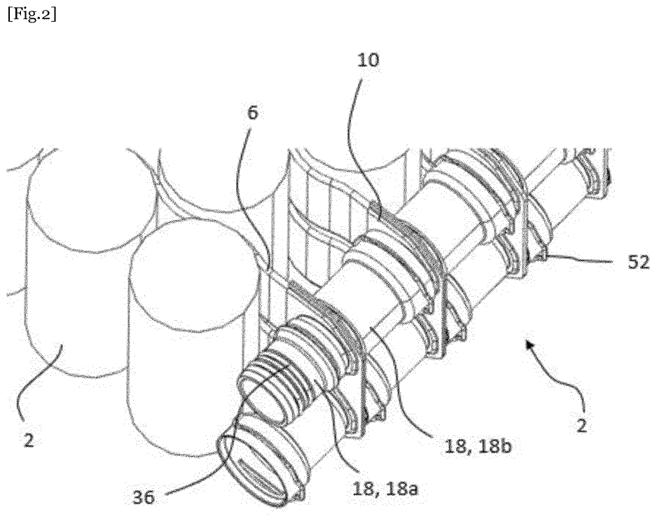

FIG. 2 is a detail view of several electrical energy storage units and of one end of several thermal regulation devices, seen in FIG. 1;

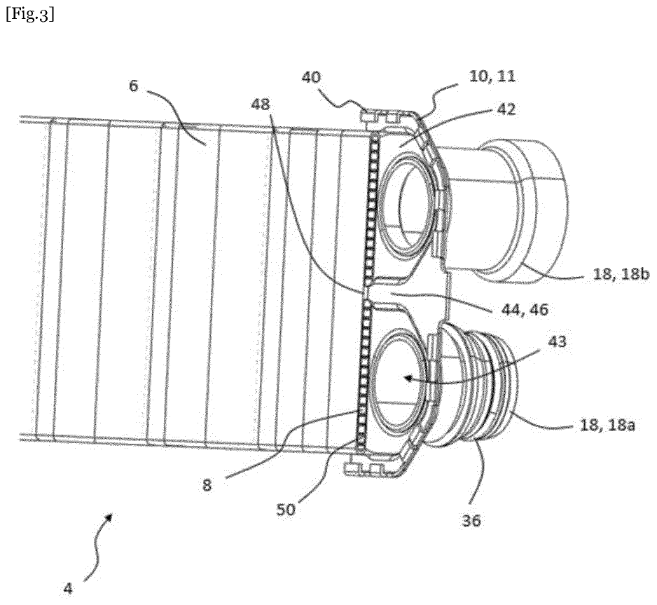

FIG. 3 is a schematic representation, in perspective, in which the distribution tank has been shown in part (a single shell) in order to make visible its internal structure and in order to make visible the internal structure of the tube to one end of which the distribution tank is fixed;

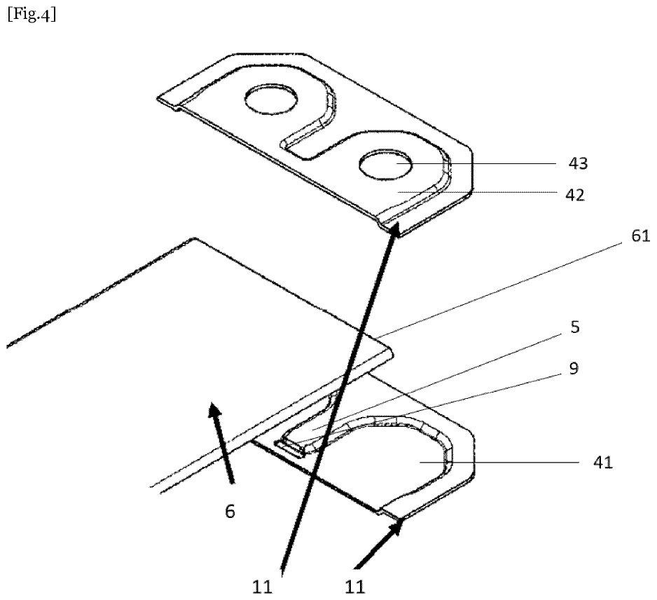

FIG. 4 is a schematic detail, in perspective, of the thermal regulation device in an exploded view;

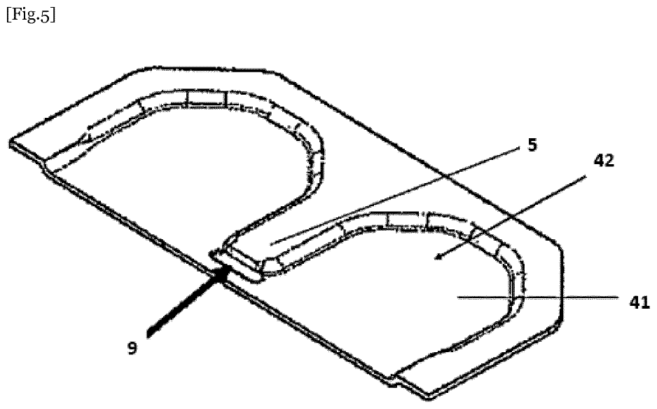

FIG. 5 is a schematic view of a shell according to a first embodiment;

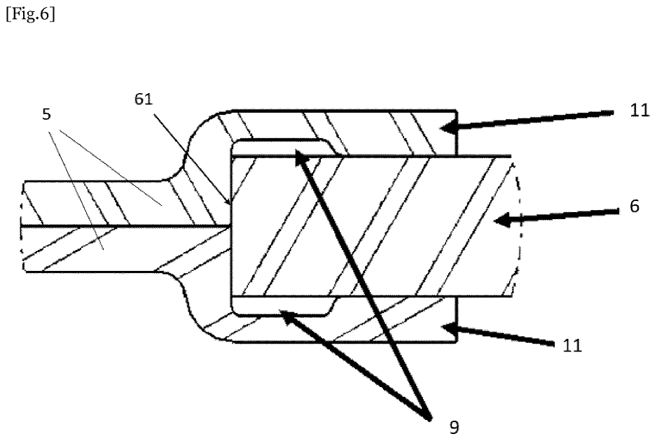

FIG. 6 shows a schematic representation, in a cutaway view, of a thermal regulation device according to a second embodiment of the invention;

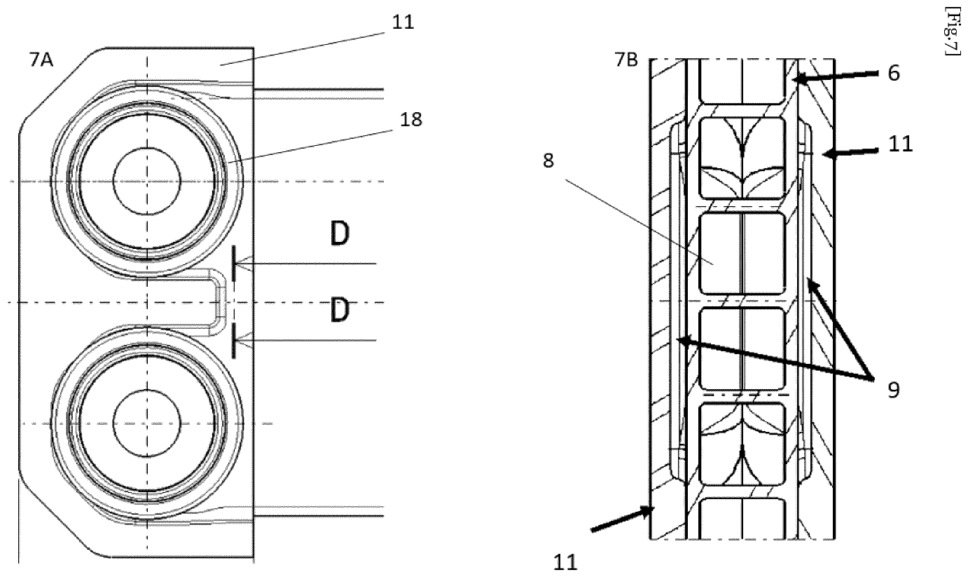

FIG. 7 is a detail in a top view (FIG. 7A) of a thermal regulation device according to a second embodiment, and in a front view (FIG. 7B) along section D-D in FIG. 7A;

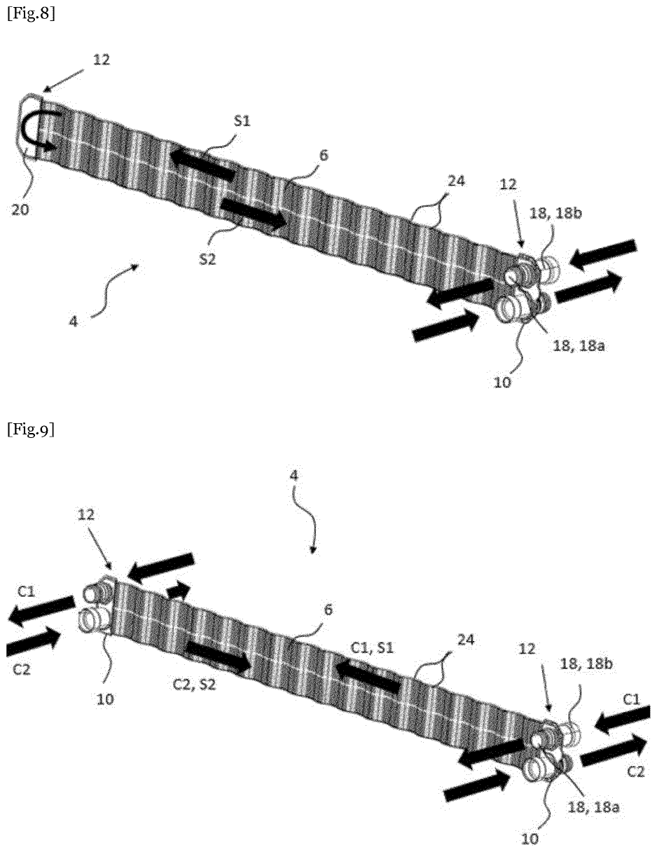

FIG. 8 is a representation, in perspective, of a thermal regulation device according to a third embodiment, in which the U-type circulation of the heat transfer fluid that is intended to circulate in this device has been represented by solid arrows;

FIG. 9 is a representation, in perspective, of a thermal regulation device according to a fourth embodiment, in which the I-type circulation of the heat transfer fluid that is intended to circulate in this device has been represented by solid arrows.

The features, variants and different embodiments of the invention may be combined with one another, according to various combinations, inasmuch as they are not incompatible or mutually exclusive. In particular, variants of the invention can be imagined comprising only a selection of features described hereinafter in isolation from the other features described, if this selection of features is sufficient to confer a technical advantage and/or to differentiate the invention from the prior art.

In the following description, the terms “longitudinal”, “transverse” and “vertical” refer to the orientation of a thermal regulation device according to the invention. A longitudinal direction corresponds to a main direction of extension of a thermal regulation device and a transverse direction corresponds to a direction that is substantially perpendicular to a main plane of extension of a thermal regulation device and to a main direction of extension of a hydraulic connecting sleeve of the thermal regulation device, this transverse direction being perpendicular to the longitudinal axis L. Lastly, a vertical direction is perpendicular to the longitudinal direction and to the transverse direction.

Accordingly, the present invention relates to a thermal regulation device (4) for cooling electrical energy storage units (2), the thermal regulation device (4) comprising a tube (6) configured to be in contact with at least one electrical energy storage unit, the tube comprising a plurality of heat transfer fluid circulation channels (8),
at least one first collecting tank (10) disposed at a first end of the tube (61), the first collecting tank (10) comprising at least two shells (11) configured to be assembled with one another to form a collecting chamber (26) which communicates fluidically with the plurality of circulation channels (8) of the tube (6),
at least one of said shells (11), preferably both shells (11), comprise at least one separating partition (5) having one end configured to be in contact with one end of the tube (6) when the two shells are assembled with said tube, in order to separate the collecting chamber (26) into at least two parts (26a, 26b) which are leak-tight with respect to one another when the shells are assembled, each of the parts communicating fluidically with one portion of the plurality of circulation channels (8), characterized in that at least one separating partition, preferably both separating partitions, is obtained by stamping, and in that the base of said separating partition comprises a stamped portion (9) forming a groove, the groove being configured to comprise the angle due to stamping, such that the end of the separating partition (5) has a face parallel to the face of the end of the tube (61).

It is understood that the core of the invention resides in the presence of a stamped portion contiguous to the end of the separating partition that is intended to be brought into contact with the end of the tube of the device in order to include the stamping radius in said stamped portion and obtain a separating partition end that is completely straight.

This advantageously permits improved overall contact between said separating partition of the tank and said tube.

Indeed, this makes it possible to ensure mutual verticality of the two faces without the tube being in contact with the residual stamping angle of the tank, more precisely of the partition, and therefore leak-tightness of the two parts with respect to one another. Ultimately, this permits separation between the incoming and outgoing flows of fluid and therefore improved and durable thermal exchange.

The invention as just described makes it possible to meet the objectives which it set itself, namely to propose an electrical energy storage device 1 that is reliable and without leaks.

The present invention further comprises the following features, taken on their own or in combination:

In some embodiments, the end of the separating partition of each shell has a vertical wall configured to be in continuous contact with the end of the tube.

In some embodiments, the separating partition is in contact with the tube in the region of at least one channel of the plurality of distribution channels.

In some embodiments, the channel in contact with the separating partition is full.

In some embodiments, the channel in contact with the separating partition is empty, the separating partition being dimensioned to block the channel when the two shells of the collecting tank are assembled with the tube.

In some embodiments, the device comprises a second stamped portion (not shown) at the top of the separating partition, said second stamped portion being configured to reduce the stamping radius of said top such that the end of the separating partition (5) has a face parallel to the face of the end of the tube (61).

This advantageously makes it possible to obtain as small a radius as possible at the top of the wall.

In other words, the second stamped portion makes it possible to reduce the stamping radius that is present in the region of the angle between the face of the end of the separating partition, which is intended to be disposed in contact with the face of the end of the tube (61), and the face forming the top of the separating partition.

In a particular embodiment, the second stamped portion is formed so as to obtain substantially a right angle in the region of the top.

In some embodiments, the device comprises a second collecting tank at a second end of the tube opposite the first end of the tube comprising the first collecting tank, the second collecting tank being identical to the first collecting tank.

In some embodiments, the two shells are symmetrical.

In some embodiments, the trough has a depth of between 0.05 mm and 0.2 mm.

In some embodiments, the collecting tank (10) is made of metal, such as aluminum, or of plastics material.

In some embodiments, at least one of the shells, preferably both shells, comprises orifices.

In some embodiments, at least two connecting sleeves (18, 18a, 18b), preferably four, are configured to communicate fluidically with the collecting chamber (26), preferably with each part of the collecting chamber (26), the connecting sleeves (18, 18a, 18b) preferably having different shapes from one another.

In some embodiments, a thermal regulation system comprises several thermal regulation devices (4) as described above, and several electrical storage units disposed in a row, the regulation devices being connected to one another by their sleeves and being configured to be in contact with said rows of storage units.

In some embodiments relating to the method according to the invention, the method comprises the following steps:
two shells are provided and are stamped so as to form a separating partition of the collecting chamber, the separating partition comprising at its base a stamped portion forming a trough having the stamping radius, also called the residual stamped portion,
the two shells are assembled with one another to form said collecting tank forming the collecting chamber,
a tube (6) comprising a plurality of heat transfer fluid circulation channels (8) is provided and is introduced into the collecting tank, such that one end of the tube is in contact with one end of the separating partition,
the assembly of the shells and the tube is fixed by soldering, adhesive bonding, welding, clipping, ultrasound, or a mixture thereof.

In some embodiments, the method further comprises a step of stamping the top of the separating partition so as to reduce the stamping radius of said top such that the end of the separating partition (5) has a face parallel to the face of the end of the tube (61).

FIG. 1 shows several cooling devices 4 with several tubes 6 assembled by their pairs of sleeves 18, with the cells 2, with the insulating shells.

FIG. 2 shows a detail of FIG. 1 which shows, in greater detail, the connection between different cooling devices.

FIG. 3 shows a view of the device in which one of the shells 11 and part of the collecting tank have not been shown. Thus, a single shell 11 and a single part of the collecting tank 10 to which it is fixed are shown.

FIG. 3 makes particularly visible the fact that the collecting tank 10 of the thermal regulation device 4 has within it at least one collecting chamber 26 which communicates fluidically with at least one of the circulation channels 8 formed within the tube, and more particularly one of the circulation assemblies 21, 22 formed by several channels.

In some embodiments, as shown by way of non-limiting example, the collecting tank 10 is formed by two parts which are attached and fixed or welded to one another, with fixing means at the periphery of the shells. At least one part has attachment feet 40 which allow the half-shells to be held together prior to a soldering operation which fixes the position of the half-shells and the stability of the collecting tank.

Each part of the collecting tank has two cavities 42 formed by deformation of said part, and a rib 44 disposed between the two cavities. It is understood that, when the two parts are fixed to one another, the cavities 42 of each part are disposed opposite one another to form the above-mentioned collecting chambers 26, and the ribs 44 of each part are in contact with one another to form a separating partition 46 which delimits and separates the collecting chambers 26 from one another.

This central wall 46 is intended to be in contact with a solid surface of the tube forming a leak-tight zone 48, which does not have circulation channels, in order to ensure leak-tight contact and prevent, within the collecting tank, fluid present in a first collecting chamber from flowing into the other collecting chamber, or into channels that must not be connected to this first collecting chamber.

Each cavity 42 is defined by a bottom wall 41, which is pierced by an orifice 43 substantially in its center. This orifice allows fluid to pass between the collecting chamber 26 formed by the cavity and a connecting sleeve 18 of the pair of connecting sleeves that opens out into this collecting chamber 26.

In other words, the connecting sleeves are configured to each communicate with a collecting chamber, and it is understood that the sleeves disposed on either side of the collecting tank are configured to communicate with the same collecting chamber.

FIG. 4 shows a simplified, exploded view of the tube 6 between the two shells 11 each comprising a separating partition 5, the stamped base of which is terminated by a stamped groove 9 which reduces the stamping radius and allows the wall of the end of the separating partition 5 to be completely straight.

FIG. 5 shows in detail this stamped portion at the base of the separating partition 5, which may be produced at the same time or in a different step.

Preferably, the stamped portion forming a groove or trough 9 is produced in the opposite direction to the stamped portion forming the separating partition 5.

In some embodiments, as shown in a non-limiting manner in FIG. 6, said two shells 11 are identical and each has a stamped portion forming the separating partition 5 and a stamped portion forming a groove or trough 9.

Indeed, advantageously, the two shells 11 are each formed of the same single part reference, in order to optimize the costs. Assembly is thus effected between two identical parts, which can be inverted relative to one another.

FIG. 7 shows a collecting tank 10 seen from above, and its internal section, where the groove 9 can be seen.

FIG. 7A makes it possible to locate section D-D (FIG. 7B). FIG. 7B shows a particular embodiment in which there can be seen the grooves 9 and the fact that the vertical wall of each half-tank blocks two channels. The number of channels that are blocked can vary and depends on the design of the device. In some alternative embodiments, a single channel is blocked.

The size of the electrical energy storage device 4 can thus easily be increased without this involving a multiplication of the assembly operations.

In an alternative embodiment, the second collecting tank is different from the first tank and forms, for example, a return section. This advantageously makes it possible to connect the outlet of the channels of the tube that is supplied with fluid coming from part of the collecting chamber that forms a fluid intake zone to the intake of the channels of the tube that is connected to part of the collecting tank that forms a fluid outlet zone.

In a preferred embodiment, each shell comprises 2 orifices allowing the intake and the discharge of fluid by way of the connecting sleeves 18. These sleeves may be formed in one piece with each shell, or be assembled and fixed subsequently.

In some embodiments, the device is configured to permit a U-type or I-type circulation of the fluid.

By way of example, an electrical energy storage device 1, notably provided to equip an electric or hybrid vehicle, comprises several assemblies of electrical energy storage units 2, also called electrical energy storage cells hereinafter, and several thermal regulation devices 4 arranged in the vicinity of the cells so as to enable a heat exchange between them.

The electrical energy storage units notably have the shape of cylindrical cells, in this case of circular section, that are disposed vertically, that is to say perpendicularly with respect to the longitudinal and transverse plane in which the electrical energy storage device is mainly inscribed.

The electrical energy storage units 2 are notably disposed in successive rows 3 that are parallel to one another, and each row, or assembly of electrical energy storage units, extends mainly longitudinally.

Thermal regulation devices 4 are disposed between two adjacent rows 3 of electrical energy storage units, notably with a tube 6 which is configured to be in contact with the electrical energy storage units 2 of these two adjacent rows 3.

In the example illustrated in FIG. 1, the rows 3 are disposed in staggered fashion with respect one another, that is to say with a longitudinal offset of the storage units of one row with respect to the storage units of the adjacent row, thus making it possible to optimize the size of the electrical energy storage device 1, and the thermal regulation devices 4 each comprise a tube 6 of corrugated shape so as to be able to be in contact with each of the electrical energy storage units 2 of the two rows 3 between which they respectively extend. In an alternative embodiment, the thermal regulation devices 4 each comprise a tube 6 of flat shape.

Heat transfer fluid is intended to circulate inside this tube 6 of corrugated shape so as to be able to exchange heat energy with the electrical energy storage units 2, via the heat-conducting wall of the tube. Notably, when the electrical energy storage units 2 have to be cooled following a rise in temperature during their operation, the heat transfer fluid is intended to recover heat energy and discharge it out of the electrical energy storage device 1. In order to allow this exchange of heat energy, each thermal regulation device 4 comprises the tube 6 mentioned above, in this case of corrugated shape, within which a plurality of channels 8 for circulating heat transfer fluid is formed, and at least one collecting tank 10 which is disposed at one longitudinal end of the tube 6 and which is intended to collect the fluid from a heat transfer fluid intake duct 14 and to distribute it into the circulation channel or channels 8 within the tube 6 and/or which is intended to collect the heat transfer fluid at the outlet of the tube 6 and to direct it into a heat transfer fluid discharge duct 16.

In other words, the heat transfer fluid is intended to circulate in the intake duct, and at each collecting tank encountered by the intake duct, a portion of heat transfer fluid is directed toward this collecting tank and the associated thermal regulation device and another portion of heat transfer fluid is directed through the remainder of the intake duct in order to supply the following collecting tank.

By way of non-limiting example, when the cooling device is used for cooling automotive battery cells, the sleeves, the collecting tank and the tube are made of a conducting material such as metal, notably of aluminum.

By way of a non-limiting example of a cooling device, the heat transfer fluid intake duct 14 and the heat transfer fluid discharge duct 16 are formed by the direct cooperation of connecting sleeves 18 that are secured to two adjacent collecting tanks 10, without there being any intermediate devices arranged between these connecting sleeves 18, it being understood that, where appropriate, a sealing gasket can be borne by one of the connecting sleeves and bear against the other connecting sleeve in the direct connecting zone between the sleeves.

Those features relating to the connecting sleeves 18 which notably enable the direct cooperation as mentioned will be described in more detail below.

It can, however, be noted at this stage in the description, according to the illustrations in FIGS. 1 and 2, that two connecting sleeves 18 extend on either side of a collecting tank 10 so as to form a pair 19, and that the two connecting sleeves 18 of this pair preferably have, as illustrated, a different shape from one another, so as to allow the sleeve of a first type 18a associated with a first collecting tank 10 to be connected directly to a sleeve of the second type 18b associated with a second collecting tank 10, without it being necessary to provide additional connecting means.

FIG. 8 illustrates an example of the thermal regulation device, in which the circulation of the fluid is referred to as U-type circulation, that is to say with the same portion of heat transfer fluid circulating in both directions within the tube 6 after having passed through a return tank 20 at one of the longitudinal ends of the tube.

More particularly, in this first embodiment, the thermal regulation device 4 comprises a tube 6 and, at each of its longitudinal ends, a collecting tank 10 and a return tank forming a return section 20.

The tube 6 comprises several channels 8 formed within it, divided into two circulation assemblies that are distinguished in that the same portion of heat transfer fluid circulates in the first circulation direction S1 within the channels of a first circulation assembly 21 and in a second circulation direction S2, opposite to the first circulation direction S1, within the channels of a second circulation assembly 22.

The collecting tank 10 disposed at a first longitudinal end 12 of the tube is equipped with connecting sleeves 18 so as to allow the intake and discharge of the heat transfer fluid. The collecting tank 10 is configured to guide the fluid circulating in the connecting sleeves 18 that contribute to forming the heat transfer fluid intake duct 14 to one portion of the channels, in this case the channels of the first circulation assembly 21, within the tube and to guide the fluid exiting the tube through the other portion of the channels, in this case the channels of the second circulation assembly 22, into the connecting sleeves 18 that contribute to forming the heat transfer fluid discharge duct 16.

The return tank 20 disposed at a second longitudinal end of the tube 6 does not comprise any connecting sleeves and is only fluidically connected to the tube 6. The return tank 20 is configured to guide the fluid circulating in one direction in one portion of the circulation channels to the other portion of the circulation channels such that it circulates in the other direction.

FIG. 9 illustrates a second example of a thermal regulation device 4, in which the circulation of the heat transfer fluid is referred to as I-type circulation, that is to say with the same portion of heat transfer fluid circulating in only one direction within the tube 6.

More particularly, in this second embodiment, the thermal regulation device 4 comprises a tube 6 and, at each of its longitudinal ends, a collecting tank 10 according to the invention.

Again, the tube 6 comprises several channels 8 formed within it, divided into two circulation assemblies that are distinguished this time in that two different portions of fluid can circulate separately within the tube, in their respective assembly of channels. A first portion of heat transfer fluid can thus circulate in the first circulation direction S1 within the channels of the first circulation assembly 21 and a second portion of heat transfer fluid can circulate in a second circulation direction S2, opposite to the first circulation direction, within the channels of the second circulation assembly 22.

This configuration results in two separate circuits, as illustrated by the arrows visible in FIG. 4. A first circuit C1 comprises entry of fluid through a first sleeve of a first collecting tank, passage of one portion of this fluid through the tube in a first circulation direction while the other portion of this fluid continues on its route through the conveying duct in the direction of an adjacent thermal regulation device, and exit of the fluid via a first sleeve of the second collecting tank after having passed through the tube, so as to join the fluid coming from the adjacent thermal regulation device. And a second circuit C2 comprises entry of fluid through a second sleeve of the second collecting tank, passage of one portion of this fluid through the tube in a second circulation direction while the other portion of this fluid continues on its route through the conveying duct in the direction of an adjacent thermal regulation device, and exit of the fluid via a second sleeve of the first collecting tank after having passed through the tube, so as to join the fluid coming from the adjacent thermal regulation device.

The invention relates primarily to a device comprising shells produced by stamping. It may, however, be applied to all processes that generate a radius at the foot of a wall. Thus, the present invention relates, inter alia, also to a similar device in which the separating partition is produced by machining, the groove then also being produced by machining.

However, the invention is not limited to the means and configurations described and illustrated here, and it likewise extends to any equivalent means or configuration and to any technical combination employing such means. By way of non-limiting example, and as has been explained above, the shapes of the sleeves may vary as long as the connecting sleeves for connecting one thermal regulation device to another are able to cooperate directly with one another.

### LIST OF REFERENCE SIGNS

1. Electrical energy storage device
2. Electrical energy storage unit
3. Row of cells
4. Thermal regulation devices
5. Separating partition
6. Tube
61. End of the tube
48. Central channel
8. Heat transfer fluid circulation channel
9. Stamped portion, trough
10. Collecting tank
11. Shells
12. Longitudinal end
14. Intake duct
16. Discharge duct
18. Connecting sleeves
18a. Sleeve of the first type
18b. Sleeve of the second type
20. Return tank
26. Collecting chambers
40. Cooperation means
41. Bottom wall
42. Cavity
43. Orifice

1. A thermal regulation device for cooling electrical energy storage units, the thermal regulation device comprising a tube configured to be in contact with at least one electrical energy storage unit, wherein the tube comprising:
a plurality of heat transfer fluid circulation channels; and
at least one first collecting tank disposed at a first end of the tube,
wherein the first collecting tank comprising at least two shells configured to be assembled with one another to form a collecting chamber which communicates fluidically with the plurality of circulation channels of the tube,
wherein at least one of said shells comprise at least one separating partition having one end configured to be in contact with one end of the tube when the two shells are assembled with said tube,
wherein in order to separate the collecting chamber into at least two parts which are leak-tight with respect to one another when the shells are assembled, each of the parts communicating fluidically with one portion of the plurality of circulation channels,
wherein at least one separating partition, is obtained by stamping,
wherein a base of said separating partition comprises a stamped portion forming a groove,
wherein the groove is configured to comprise an angle due to stamping, such that the end of the separating partition has a face parallel to the face of the end of the tube.

2. The thermal regulation device as claimed in claim 1, in which the end of the separating partition of each shell has a vertical wall configured to be in continuous contact with the end of the tube.

3. The thermal regulation device as claimed in claim 1, in which the separating partition is in contact with the tube in a region of at least one channel of a plurality of distribution channels.

4. The thermal regulation device as claimed in claim 3, in which the channel in contact with the separating partition is full.

5. The thermal regulation device as claimed in claim 3, in which the channel in contact with the separating partition is empty, wherein the separating partition is dimensioned to block the channel when the two shells of the collecting tank are assembled with the tube.

6. The thermal regulation device as claimed in claim 1 further comprising a second stamped portion at a top of the separating partition, said second stamped portion is configured to reduce a stamping radius of said top such that the end of the separating partition has a face parallel to the face of the end of the tube.

7. The thermal regulation device as claimed in claim 1 further comprising a second collecting tank at a second end of the tube opposite the first end of the tube comprising the first collecting tank, wherein the second collecting tank is identical to the first collecting tank.

8. The thermal regulation device as claimed in claim 1, in which the two shells are symmetrical.

9. The thermal regulation device as claimed in claim 1, in which the stamped portion forms a trough having a depth of between 0.05 mm and 0.2 mm.

10. The thermal regulation device as claimed in claim 1, in which the collecting tank is made of metal, or of plastics material.

11. The thermal regulation device as claimed in claim 1, in which at least one of the shells, comprises orifices.

12. The thermal regulation device as claimed in claim 11, in which at least two connecting sleeves are configured to fluidically communicate with the collecting chamber, wherein the connecting sleeves having different shapes from one another.

13. A thermal regulation system comprising several thermal regulation devices as claimed in claim 1, and several electrical storage units disposed in a row, the regulation devices is connected to one another by their sleeves and is configured to be in contact with said rows of storage units.

14. A method for assembling a thermal regulation device as claimed in claim 1, said method comprising:
providing and stamping two shells so as to form a separating partition of the collecting chamber,
wherein the separating partition comprising at its base a stamped portion forming a trough having a stamping radius;
assembling the two shells with one another to form said collecting tank forming the collecting chamber;
providing and introducing a tube comprising a plurality of heat transfer fluid circulation channels into the collecting tank, such that one end of the tube is in contact with one end of the separating partition; and
fixing the assembly of the shells and the tube by soldering, adhesive bonding, welding, clipping, ultrasound, or a mixture thereof.

15. The method for assembling a thermal regulation device as claimed in claim 14, said method further comprising stamping a top of the separating partition so as to reduce the stamping radius of said top such that the end of the separating partition has a face parallel to the face of the end of the tube.

16. A method for assembling a thermal regulation device, the method comprising:
stamping at least one shell to form a separating partition defining a portion of a collecting chamber, wherein stamping the separating partition includes forming a stamped groove at a base of the separating partition adapted to accommodate a stamping radius angle resulting from forming the separating partition; and
assembling the at least one shell with a second shell to form a collecting tank bounding the collecting chamber, wherein the separating partition divides the collecting chamber into at least two leak-tight chamber portions.

17. The method as claimed in claim 16, further comprising:
inserting an end of a heat transfer tube including a plurality of fluid circulation channels into the collecting tank such that an end face of the tube abuts an end face of the separating partition, wherein the stamped groove accommodates the stamping radius angle to establish continuous, parallel contact between the end face of the tube and the end face of the separating partition; and
securing the collecting tank to the tube.

18. A method for assembling a thermal regulation device, the method comprising:
providing and stamping two shells so as to form a separating portion of a collecting chamber;
assembling the two shells with one another to form a collecting tank of the collecting chamber; and
providing and introducing a tube into the collecting tank, such that one end of the tube is in contact with one end of the separating partition.

19. The method of claim 18, wherein the separating partition comprises at its base a stamped portion forming a trough having a stamping radius.

20. The method of claim 18, further comprising:
fixing the assembly of the shells and the tube by soldering, adhesive bonding, welding, clipping, ultrasound, or a mixture thereof.
